(19) United States
(12) Patent Application Publication
(10) Pub. No.: US 2026/0113269 A1
(43) Pub. Date: Apr. 23, 2026

(54) TRIGGERED ROLE CHANGES FOR NETWORKED DEVICES

(71) Applicant: Apple Inc., Cupertino, CA (US)

(72) Inventors: Venkateswara Rao MANEPALLI, San Jose, CA (US); Sarvesh Kumar VARATHARAJAN, Milpitas, CA (US); Arun Vijayakumari MAHASENAN, Fremont, CA (US)

(21) Appl. No.: 19/295,516

(22) Filed: Aug. 8, 2025

Related U.S. Application Data
(60) Provisional application No. 63/708,686, filed on Oct. 17, 2024.

(51) Int. Cl. H04L 45/28; H04L 45/03; H04L 45/42

(52) U.S. Cl. CPC H04L 45/28; H04L 45/03; H04L 45/42

(57) ABSTRACT

The subject technology provides for triggered role changes for networked devices. The networked devices may be devices connected to a mesh network. The subject technology may provide for efficient handoff of a leader role to a backup leader device in the event of a failure or other outage at a current leader device.

### CROSS REFERENCE TO RELATED APPLICATIONS

This application claims the benefit of priority to U.S. Provisional Ser. No. 63/708,686, entitled, “Triggered Role Changes for Networked Devices”, filed on Oct. 17, 2024, the disclosure of which is hereby incorporated herein in its entirety.

### TECHNICAL FIELD

The present description generally relates to wireless communication systems and, in particular, to triggered role changes for networked devices.

### BACKGROUND

A mesh network may include router devices to forward packets between end devices of the network. That is, the end devices communicate with a corresponding router of the network but may not forward packets for other network devices. In this way, the router may act as a parent device for the end devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates a block diagram of an example system for mesh network communication in accordance with one or more implementations.

FIG. 3 illustrates an example of a mesh network with a leader and one or more backup leader candidates in accordance with one or more implementations.

FIG. 4 is a sequence diagram illustrating operations that may be performed for backup leader candidate selection in accordance with one or more implementations.

FIG. 5 is a sequence diagram illustrating operations that may be performed for a soft handoff of a leader role in a mesh network in accordance with one or more implementations.

FIG. 6 is a sequence diagram illustrating operations that may be performed for a hard handoff of a leader role in a mesh network in accordance with one or more implementations.

FIG. 7 is a flow chart of an example process that may be performed by a leader in a mesh network in accordance with one or more implementations.

FIG. 8 is a flow chart of an example process that may be performed by a backup leader device in accordance with one or more implementations.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the present disclosure relate to enabling communication between devices of a network. In one or more implementations, the network may include a mesh network, and communication between devices on the network may be performed in accordance with a mesh network communication protocol for the mesh network. In one or more implementations, the mesh network communication protocol may be a Thread® network protocol, as defined in the Thread 1.3.0 Specification. However, the disclosed subject matter is applicable to any networking environment.

In one or more implementations, the roles of various devices in a mesh network can be dynamically selected and/or changed. As an example, router-eligible end devices (REEDs) may act as end devices or routers at various times during operation of the mesh network. A device that performs a leader role for the mesh network may assign router addresses, and may allow or decline new router requests (e.g., from new routers requesting to join the mesh network, and/or router-enabled end devices requesting to upgrade to act as routers), among other leader operations performed by that device.

The device that performs the leader role may be elected (e.g., self-elected) from among various routers and/or router-eligible end devices, such as based on a high fault tolerance at that device. In the event that a failure (e.g., an outage, such as due to a software update, powering off of the device, or a power outage) occurs at a device performing a leader role, another router may assume the leader role for the mesh network (e.g., without user interaction to establish the new leader). However, a network disruption can occur during the time in which the leader fails, the leader failure is identified by other devices in the mesh network, and a new leader is established. For example, in the event of a leader outage or other failure, all other routers in the mesh network may determine that the leader has failed at approximately the same time (e.g., upon a determination that four expected advertisements from the leader have not been received, such as is defined in the Thread® network protocol), which can cause a delay in restoring the network while multiple other routers coordinate to elect a new leader (e.g., a delay including the time to wait for the four missing advertisements that would have been transmitted from the leader, and the time to coordinate among the other routers to elect a new leader).

Aspects of the subject technology can help to reduce the network disruption caused by a leader failure in a mesh network. For example, aspects of the subject technology include a leader identifying one or more backup leader candidates, notifying the backup leader candidates that they are backup leader candidates, and providing network management information to the backup leader candidates. The backup leader candidates can then monitor for a leader failure, and be configured to more quickly establish a new leader in the event of a detected failure.

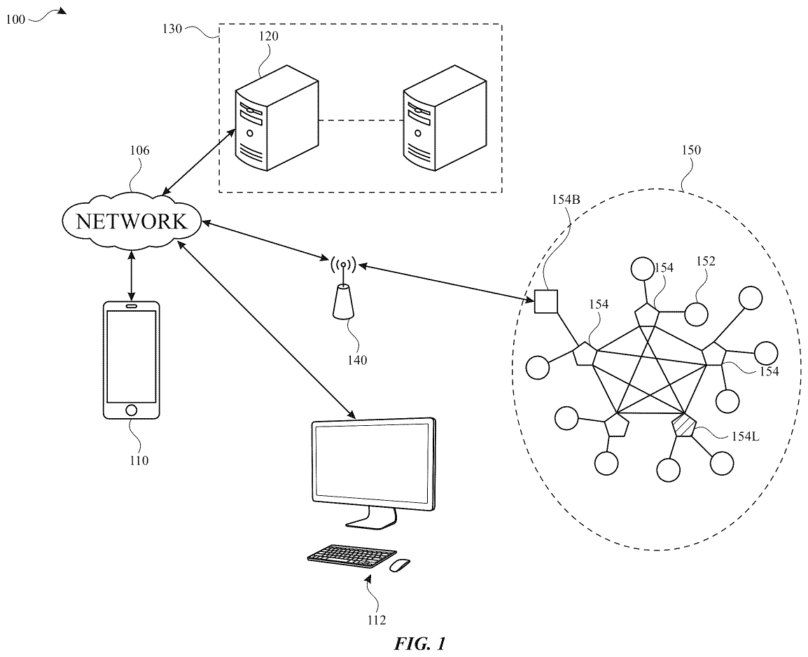

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100, which may operate in conjunction with the IEEE 802.15.4 standards for low-rate wireless personal area networks (LR-WPANs). It is understood that the concepts disclosed herein may also be applied to other networks, including Thread®, Zigbee®, Z-Wave®, Bluetooth Low Energy (BLE), ISA100.11a, WirelessHART®, MiWi™, IPv6 over Low-Power Wireless Personal Area Networks (6LoWPAN), Subnetwork Access Protocol (SNAP), Wi-Fi mesh networks, and the like.

In the example of FIG. 1, the network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

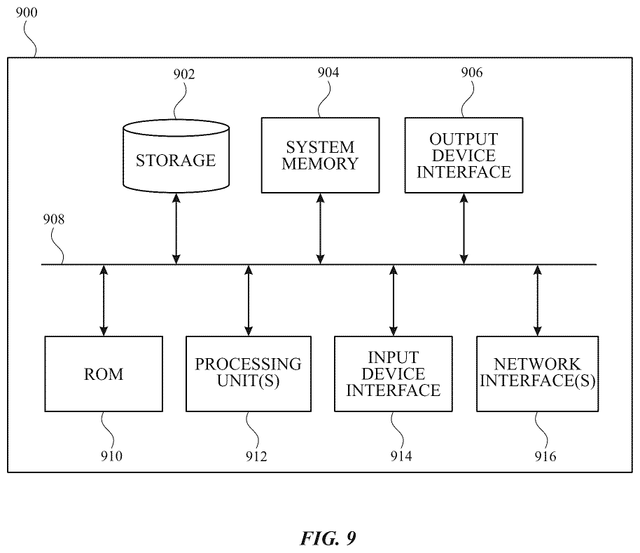

The electronic device 110 may be, for example, a desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 9.

The electronic device 112 may be, for example, desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 9.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users. Although the electronic device 110 and the electronic device 112 are depicted as being outside the mesh network 150, in various use cases, and/or at various times, the electronic device 110 and/or the electronic device 112 may be included in the mesh network 150.

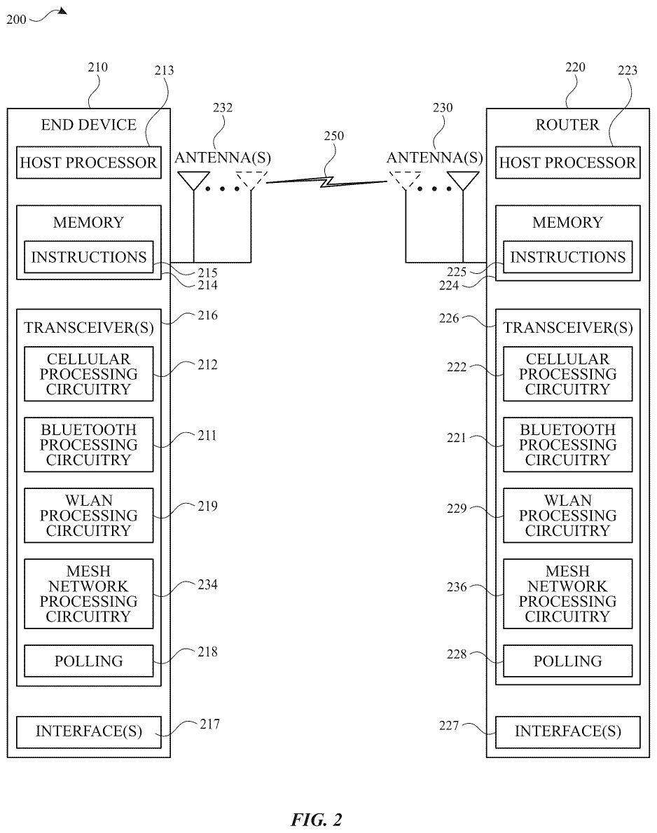

In the example of FIG. 1, the mesh network 150 includes various end devices 152 and routers 154 (each of which may include any one of the electronic devices 110 or 112, and/or other electronic devices). In one or more implementations, the routers 154 (represented as pentagons in the figure) may forward packets (e.g., data) between and/or to the end devices 152 (represented as circles in the figure) of the mesh network 150. In some use cases, a router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive and transmit packets.

In one or more implementations, the end devices 152 and the routers 154 may communicate according to a mesh network communication protocol (e.g., a Thread® network protocol) for the mesh network 150. For example, the mesh network communication protocol may govern how a device acting as a router 154 forwards packets between end devices 152 of the mesh network 150. In one or more implementations, each device acting as a router 154 may act as a parent device for one or more of the end devices 152. The parent device may provide connectivity for, and manage communication with, the end devices that are child devices of that parent device. As such, an end device 152 may utilize a radio thereof to transmit a message to another end device 152, e.g., over the mesh network 150, via at least its parent router 154. As shown in FIG. 1, a mesh network, such as mesh network 150, may include multiple devices acting as routers 154. Devices that may act as routers 154 in the mesh network 150 may include devices that are specifically implemented (e.g., in hardware) as routers, and/or router-eligible end devices that can act as end devices and can perform router operations for other end devices.

Each end device 152 of the mesh network 150 may communicate primarily with a single router 154, which may be referred to as a parent (or parent device) of that end device 152. For example, the end devices 152 may not forward packets for other network devices (e.g., end devices 152 and router 154).

As discussed herein, in various implementations and/or use cases, the roles of various devices in the mesh network 150 may be dynamic. For example, if a router 154 does not have any child devices (e.g., communicatively coupled end devices 152), the router 154 may be downgraded and/or configured to operate as an end device 152. In another example, if a new end device attempting to join the mesh network 150 is within range of a current end device 152 of the mesh network 150 (but not a router 154), and that end device 152 is eligible to become a router 154 (e.g., is a router-eligible end device), that end device 152 may be upgraded and/or configured to operate as a router 154 for the new end device 152. In that case, the new router 154 acts as a router 154 with respect to the new end device and may be communicatively coupled to one or more other routers 154 of the mesh network 150.

Examples of device that can operate as end devices 152 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some or all of the end devices 152 may be referred to as Internet-of-Things (IoT) devices. Some or all of the end devices 152 may have the capability of acting as a router 154, some of the end devices 152 may not have the capability of acting as routers, and/or some of the routers 154 may be specifically implemented (e.g., in hardware) as routers and may not have the capability of acting as an end device. As examples, the routers 154 may be implemented as routers or router-enable end devices (REEDs) that can act as routers or end devices. Examples of REEDs include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device with the capability (e.g., hardware and software capabilities) of acting as a router (e.g., forwarding packets for other devices).

In one or more implementations, a router 154 of the mesh network 150 may perform leader role for the mesh network 150. For example, the mesh network 150 of FIG. 1 includes a router 154 that serves as a leader 154L (e.g., a leader node) in the mesh network 150. For example, the leader 154L may perform a leader role in the mesh network. In one or more implementations, performing the leader role may include managing the overall network structure and operation of the mesh network 150, including initialization, synchronization, and topological control. Performing the leader role may include aggregating and distributing network-wide confirmation information to the other routers 154 and the end devices 152 of the mesh network 150. Performing the leader role may include determining whether a router-eligible end device (REED) acting as an end device 152 in the mesh network 150 is authorized to upgrade to act as a router 154 in the mesh network 150, and/or determining whether a REED acting as a router 154 in the mesh network 150 is authorized to downgrade to act as an end device 152 in the mesh network 150.

In one or more implementations, a router 154 of the mesh network 150 may forward information between the mesh network and a non-mesh network, such as a Wi-Fi network. For example, the border router 154B may forward information between the mesh network 150 and a non-mesh network, such as the network 106, such as through the access point 140. In that case, the router may be referred to as a border router 154B, and may convert a Wi-Fi message to the mesh network communication protocol and transmit the converted mesh network message to a target end device 152 for the message using a mesh network radio. For explanatory purposes, only the router 154B is illustrated as being connected to the access point 140, however, it is appreciated that the mesh network 150 may include more than one border router (e.g., one or more of the other routers 154 may also be configured to act as a border router 154B) connected to the access point 140 in some implementations.

FIG. 2 illustrates a block diagram of an example of a system 200 including an end device and a router of a mesh network in accordance with one or more implementations. The system 200 may be a portion of the network environment 100. The end device 210 may be, for example, one of the end devices 152 of the mesh network 150. The router 220 may be, for example, one of the routers 154 of the mesh network 150.

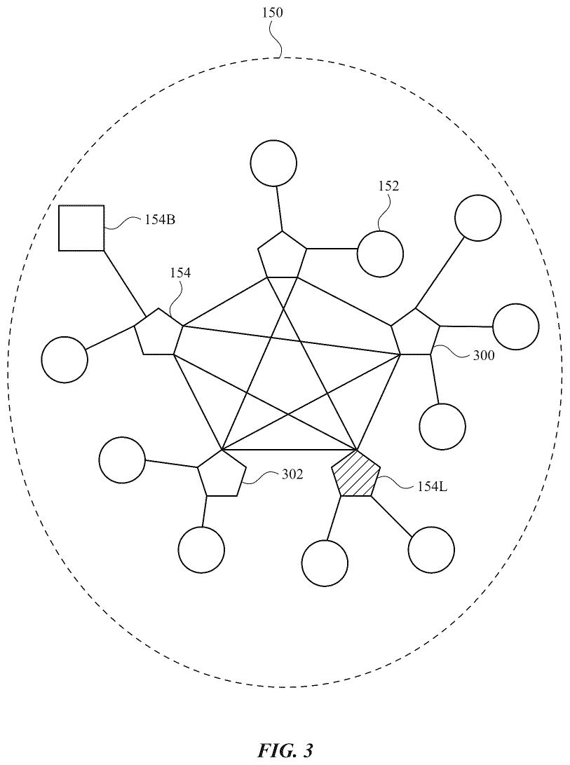

As shown in FIG. 2, the end device 210 may include a host processor 213. The host processor 213 may execute instructions such that various operations of the end device 210 are performed. For example, the host processor 213 can serve as the CPU responsible for executing instructions and managing various tasks, such as the operations described herein in connection with FIGS. 3-8. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The end device 210 may include one or more transceiver(s) 216 that may include radio frequency (RF) transmitter and/or receiver circuitry that use the antenna(s) 232 of the end device 210 to facilitate signaling (e.g., the signaling 250) to and/or from the end device 210 with other devices (e.g., the router 220) according to corresponding wireless communication protocols (e.g., Thread, cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the end device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The end device 210 may include memory 214. The memory 214 may include a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The end device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the end device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The end device 210 may include Bluetooth processing circuitry 211. The Bluetooth processing circuitry 211 is responsible for managing the transmission and reception of wireless signals to and from mobile devices (e.g., end device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the end device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

The end device 210 may include WLAN processing circuitry 219. The WLAN processing circuitry 219 is responsible for managing the transmission and reception of wireless signals to and from mobile devices (e.g., end device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the end device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

The end device 210 may include mesh network processing circuitry 234. The mesh network processing circuitry 234 is responsible for managing the transmission and reception of wireless signals to and from mobile devices (e.g., end device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the end device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 may be responsible for converting digital data from the mesh network processing circuitry 234 into radio signals for transmission over the air and for receiving incoming radio signals, which are then converted back into digital data for processing by the mesh network processing circuitry 234. This collaboration enables the end device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the end device 210.

The end device 210 may include one or more antenna(s) 232 (e.g., one, two, four, or more). In implementations having multiple antenna(s) 230, the router 220 may perform multiple-in-multiple-out (MIMO), digital beamforming, analog beamforming, beam steering, etc. For implementations with multiple antenna(s) 232, the end device 210 may leverage the spatial diversity of such multiple antenna(s) 232 to send and/or receive multiple different data streams on the same time and frequency resources.

The end device 210 may include one or more interface(s) 217. The interface(s) 217 may be used to provide input to or output from the end device 210. For example, an end device 210 that is a UE may include interface(s) 217 such as microphones, speakers, a touchscreen, buttons, and the like to allow for input and/or output to the UE by a user of the UE. Other interfaces of such a UE may be made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The end device 210 may include polling block 218. The polling block 218 may be implemented via hardware, software, or combinations thereof. For example, the polling block 218 may be implemented as a processor, circuit, and/or instructions 215 stored in the memory 214 and executed by the host processor 213 and/or the transceiver 216. In some examples, the polling block 218 may be integrated within the transceiver(s) 216. For example, the polling block 218 may be implemented by a combination of software components (e.g., executed by a DSP or a general processor) and hardware components (e.g., logic gates and circuitry) within the transceiver(s) 216. In other examples, the polling block 218 is a separate component from the transceiver(s) 216.

The router 220 may include a host processor 223. The host processor 223 may execute instructions such that various operations of the router 220 are performed. For example, the host processor 223 can serve as the central processing unit (CPU) responsible for executing instructions and managing various tasks, such as one or more of the operations described herein in connection with FIGS. 3-8. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The router 220 may include one or more transceiver(s) 226 that may include RF transmitter and/or receiver circuitry that use antenna(s) 230 of the router 220 to facilitate signaling (e.g., the signaling 250) to and/or from the router 220 with other devices (e.g., the end device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the router 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The router 220 may include memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The router 220 may include cellular processing circuitry 222. The cellular processing circuitry 222 is responsible for managing the transmission and reception of wireless signals to and from mobile devices (e.g., end device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the router 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

The router 220 may include Bluetooth processing circuitry 221. The Bluetooth processing circuitry 221 is responsible for managing the transmission and reception of wireless signals to and from mobile devices (e.g., end device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the router 220 are performed, as described herein. The Bluetooth processing circuitry 221 may include one or more processors implemented using, for example, a CPU, a DSP, an ASIC, a controller, an FPGA device, another hardware device, a firmware device, or any combination thereof configured to perform the operations described herein.

The router 220 may include WLAN processing circuitry 229. The WLAN processing circuitry 229 is responsible for managing the transmission and reception of wireless signals to and from mobile devices (e.g., end device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the router 220 are performed, as described herein. The WLAN processing circuitry 229 may include one or more processors implemented using, for example, a CPU, a DSP, an ASIC, a controller, an FPGA device, another hardware device, a firmware device, or any combination thereof configured to perform the operations described herein.

The router 220 may include mesh network processing circuitry 236. The mesh network processing circuitry 236 is responsible for managing the transmission and reception of wireless signals to and from mobile devices (e.g., end device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the router 220 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the router 220 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the router 220.

The router 220 may include one or more antenna(s) 230 (e.g., one, two, four, or more). In implementations having multiple antenna(s) 230, the router 220 may perform multiple-in-multiple-out (MIMO), digital beamforming, analog beamforming, beam steering, etc.

The router 220 may include one or more interface(s) 227. The interface(s) 227 may be used to provide input to or output from the router 220. For example, a router 220 may include interface(s) 227 made up of transmitters, receivers, and other circuitry (e.g., other than the transceiver(s) 226/antenna(s) 230 already described) that enables the router 220 to communicate with other equipment in the mesh network 150, and/or that enables the router 220 to communicate with external networks, computers, databases, and the like for purposes of operations, administration, and maintenance of the router 220 or other equipment operably connected thereto.

The router 220 may include a polling block 228. The polling block 228 may be implemented via hardware, software, or combinations thereof. For example, the polling block 228 may be implemented as a processor, circuit, and/or instructions 225 stored in the memory 224 and executed by one or more components in the transceiver 226. In some examples, the polling block 228 may be integrated within the transceiver(s) 226. For example, the polling block 228 may be implemented by a combination of software components (e.g., executed by a DSP or a general processor) and hardware components (e.g., logic gates and circuitry) within the transceiver(s) 226. In other examples, the polling block 228 is a separate component from the transceiver(s) 226.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may all be shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, the router 220 may operate as the leader 154L of FIG. 1, or a backup leader device or backup leader device candidate. In one or more use cases, an outage or other failure may occur at the leader 154L. Outages and/or failures can include planned outages (e.g., a software or firmware update), and/or unplanned outages (e.g., a hardware or software malfunction, a user powering off the router, or a power outage that cuts a power supply to the router). In order, for example, to minimize or reduce the effect on the mesh network 150 of an outage or other failure at the leader 154L, in one or more implementations, the leader 154L may designate one or more other devices in the mesh network as a backup leader device prior to the outage and/or failure.

For example, FIG. 3 illustrates a block diagram of the mesh network 150 in which the leader 154L has multiple one-hop neighbor devices, such as device 300 (e.g., a router 154 or a REED acting as a router 154 in the mesh network 150) and device 302 (e.g., another router 154 or a REED acting as a router 154 in the mesh network 150). In one or more implementations, a one-hop neighbor of the leader 154L may be any device within the mesh network 150 that is directly reachable via the wireless interface of the leader 154L. For example, the leader 154L may designate a device 300 and/or a device 302 as a backup leader device. In one or more implementations, the leader 154L may designate multiple other devices (e.g., multiple one-hop neighbors, such as both of the devices 300 and 302) as backup leader device candidates.

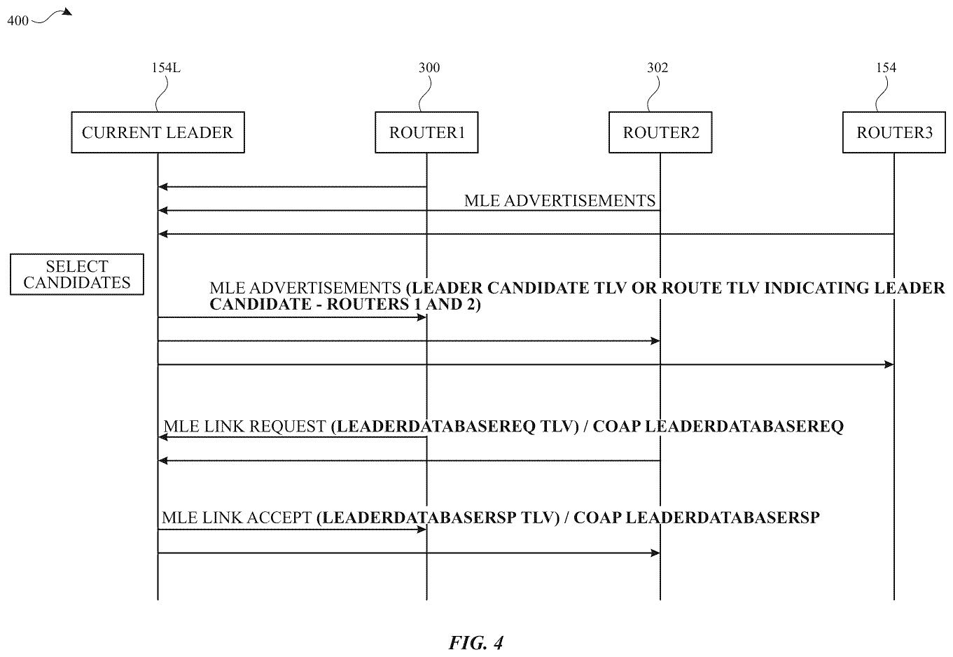

For example, FIG. 4 is a sequence diagram 400 illustrating communications between the leader 154L and one or more other routers 154 (e.g., one-hop neighbors, such as device 300, device 302, and/or one or more other routers 154 that are one hop from the leader) for establishing one or more backup leader devices. For example, as shown in FIG. 4, the leader 154L may receive communications (e.g., advertisements, such as Mesh Link Establishment (MLE) advertisements) from one or more other routers 154 in the mesh network, such as the device 300, the device 302, and/or one or more other routers 154. Based on the received communications, the leader 154L may evaluate attributes of its one-hop neighbors, such as a 2-way link quality, a leader weight, a thread version, connectivity information, and/or Thread Radio Encapsulation Link (TREL) capabilities of multiple (e.g., all) of its one-hop neighbors. Based on these attributes of the one-hop neighbors, the leader 154L may select one, two, or more than two of the one-hop neighbors as backup leader device candidates for the mesh network 150. In one or more implementations, a priority for each of the candidates may be determined by the leader 154L based on an evaluation of how closely each of the one-hop neighbor devices meet one or more criteria for these attributes.

In the example of FIG. 4, the leader 154L designates the device 300 and the device 302 as backup leader device candidates. As shown in FIG. 4, in one or more implementations, the leader 154L may provide communications to the device 300, the device 302, and/or one or more other routers 154 (e.g., all other routers 154, and/or all end devices 152) with an indication that the device 300 and the device 302 have been designated as backup leader device candidates. As examples, the communications may include additional advertisements, such as MLE advertisements (e.g., a leader candidate Type-Length-Value (TLV) message or a route TLV indicating the backup leader device candidates). In one or more implementations, the backup leader device candidates may be listed in an order in the TLV that indicates a priority, determined by the leader 154L, of each of the backup leader device candidates to become the leader in case of a drop of the current leader 154L from the mesh network 150.

As shown in FIG. 4, the leader 154L may receive, at a later time after providing the indication that the device 300 and the device 302 have been designated as backup leader device candidates, from the backup leader device candidates (e.g., the device 300 and the device 302) , a request for network management information (e.g., leader database information) for operating in the leader role. For example, the request may be provided in the form of a CoAP GetLeaderDump message (e.g., CoAP LeaderDatabaseReq) or a MLE Link request message with a new TLV type (e.g., LeaderDatabaseReq TLV) to request this network management information, in one or more implementations.

As shown in FIG. 4, responsive to the requests from the device 300 and the device 302 (e.g., and while the leader 154L continues to perform the leader role for the mesh network 150), the leader 154L may provide, to the device 300 and the device 302, the requested network management information for operating in the leader role. As examples, the network management information (e.g., leadership database information) may include a router identifier map (e.g., router ID allocations indicating current router IDs that are allocated in the mesh network 150), extended address information, 6LowPAN context information, and/or other information to be used by the device 300 and the device 302 to configure themselves to assume the leader role in the event of an outage or other failure at the leader 154L. As examples, the network management information may be provided in a CoAP LeaderDumpResponse (e.g., a CoAP LeaderDatabasRsp) or a MLE Link Accept message (e.g., with a LeaderDatabaseRsp TLV). In one or more implementations, the network management information may be unicast, by the leader 154L, to each of the device 300 and the device 302.

In one or more implementations, the requests for network management information may be repeated from the device 300 and the device 302 to the leader 154L periodically, and/or may be provided responsive to a change in the mesh network 150 (e.g., a change in connectivity information for the mesh network 150, such as a router added or removed in a Route TLV).

Once the network management information has been received at each of the backup leader device candidates (e.g., the device 300 and the device 302 in the example of FIG. 4), each of the backup leader device candidates may be configured to assume the leader role. Once the backup leader candidate devices are configured to assume the leader role, each of the backup leader candidate devices may monitor communications over the mesh network 150 for events which can trigger an attempt to become the leader. Triggering events can include an outage, failure, or disconnection of the leader 154L in any of various scenarios, including a planned outage at the leader 154L or unplanned outage at the leader 154L.

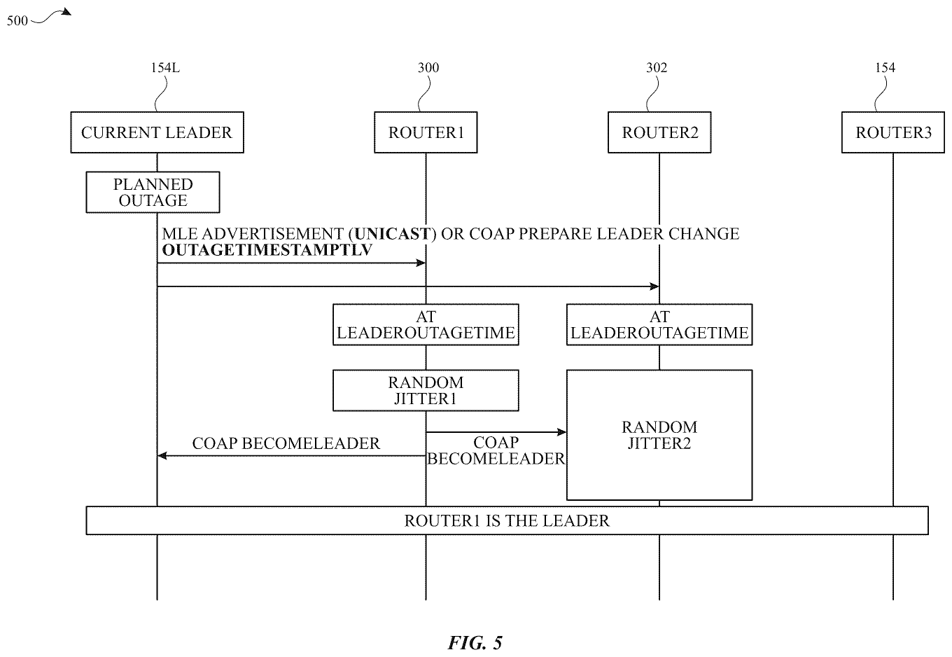

FIG. 5 is a sequence diagram 500 illustrating operations that may be performed in the event of a planned outage at the leader 154L, such as for a software or firmware update at the leader 154L. In one or more examples, the operations of FIG. 5 are described herein as a soft handoff of the leader role from the leader 154L to one of the backup leader device candidates. As shown in FIG. 5, the leader 154L may identify an upcoming event (e.g., a planned outage, such as a software update). For example, the planned outage may be an outage that is expected to last for a duration longer than a network timeout value (e.g., one hundred twenty seconds in some examples). As shown, the leader 154L may provide, to the device 300 and the device 302 that have been designated as backup leader devices, responsive to identifying the upcoming event, a notification to assume the leader role for the mesh network at a specified upcoming time (e.g., an outage time, such as a LeaderOutageTime). As examples, the notification may be provided in the form of an MLE Advertisement (e.g., a unicast transmission to each of the devices 300 and 302) or via a CoAP PrepareLeaderChange message that includes the notification.

Responsive to receiving the notification from the leader 154L, each of the backup leader candidate devices may pick a different jitter value for attempting to assume the leadership role. For example, the device 300 and the device 302 may each pick a jitter value that depends on the (e.g., different) priority identified for that device in the prior indication (from the leader 154L) of the backup leader candidate devices. In the example of FIG. 5, the device 300 has a higher priority (e.g., set by the leader 154L) than the priority of the device 302 (e.g., also set by the leader 154L), and hence has a shorter jitter time. As shown, the device 300 may, after its jitter time (e.g., Random Jitter1) following the outage time indicated by the leader 154L, attempt to assume the leader role (e.g., by providing a message, such as a CoAP BecomeLeader message) to the leader 154L and the device 302.

In the example of FIG. 5, the device 300 does not receive any rejection of its attempt to become the leader (e.g., from the current leader 154L, such as if the current leader 154L is, in fact, still operating as the leader at the previously indicated outage time), and the device 300 (e.g., Router1 in FIG. 5) becomes the leader for the mesh network 150. In this example, because the jitter value for device 302 is larger than the jitter value for device 300, the device 300 becomes the leader before the device 302 attempts to become the leader. However, in other use cases (e.g., use cases in which the device 300 is not available at the outage time and does not attempt to become the leader, or otherwise fails to become the leader), the device 302 may attempt to assume the leader role (e.g., by providing a message, such as a CoAP BecomeLeader message) to the current leader 154L and the device 300.

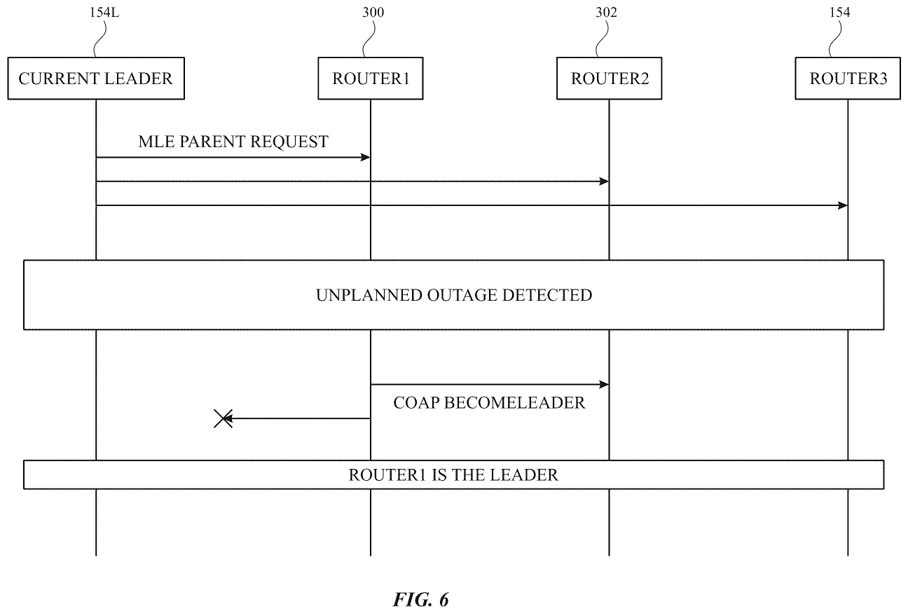

In the example of FIG. 5, the device 302 assumes the leader role from the leader 154L in a soft handoff operation. However, in other use cases, the leader 154L may become unavailable unexpectedly (e.g., the device performing the leader role may be powered down or lose network connectivity). FIG. 6 is a sequence diagram illustrating operations that may be performed in the event of an unplanned outage at the leader 154L. As discussed herein, once the backup leader candidate devices are configured to assume the leader role, each of the backup leader candidate devices may monitor communications over the mesh network 150 for events which can trigger an attempt to become the leader. In the case of an unplanned outage, triggering events may include a parent request from the leader 154L (e.g., which would indicate that the device formerly operating as the leader 154L has been disconnected, is newly attempting to connect to the mesh network, and is no longer operating as the leader), or one or more expected advertisements (e.g., MLE advertisements) not being received from the leader 154L (e.g., which would indicate that the device formerly operating as the leader 154L is not in communication with the mesh network 150).

In the example of FIG. 5, the leader 154L (in this portion of FIG. 5, the device formerly operating in the leader role for the mesh network 150 and no longer operating in the leader role) provides a parent request (e.g., an MLE parent request) to the other routers in the mesh network, including the device 300 and the device 302 that have been designated as backup leader device candidates. As shown, receiving the parent request from the device considered to be the leader 154L results in an outage detection by the device 300 and the device 302. As shown, the device 300 then provides a communication (e.g., a CoAP BecomeLeader message, as discussed in the example of FIG. 5) to inform the other candidates (e.g., device 302) and the previous leader 154L of its intent (e.g., attempt) to become the leader for the mesh network 150.

In the example of FIG. 6, the device 300 does not receive any rejection of its attempt to become the leader (e.g., from the current leader 154L or the device 302), and the device 300 (e.g., Router1 in FIG. 5) becomes the leader for the mesh network 150. For example, in a case of false detection by the device 300, (e.g., in which leader candidate attempts to become a leader while the current leader 154L is, in fact, healthy and active), the current leader 154L can deny the request (e.g., via a CoAP BecomeLeaderResponse message). In the example of FIG. 6, the different jitter values of the device 300 and the device 302 are not indicated for simplicity. However, it is appreciated that the device 300 and the device 302 may attempt to assume the leader role at different respective times based on their different respective jitter values, as in the case of the planned outage of FIG. 5.

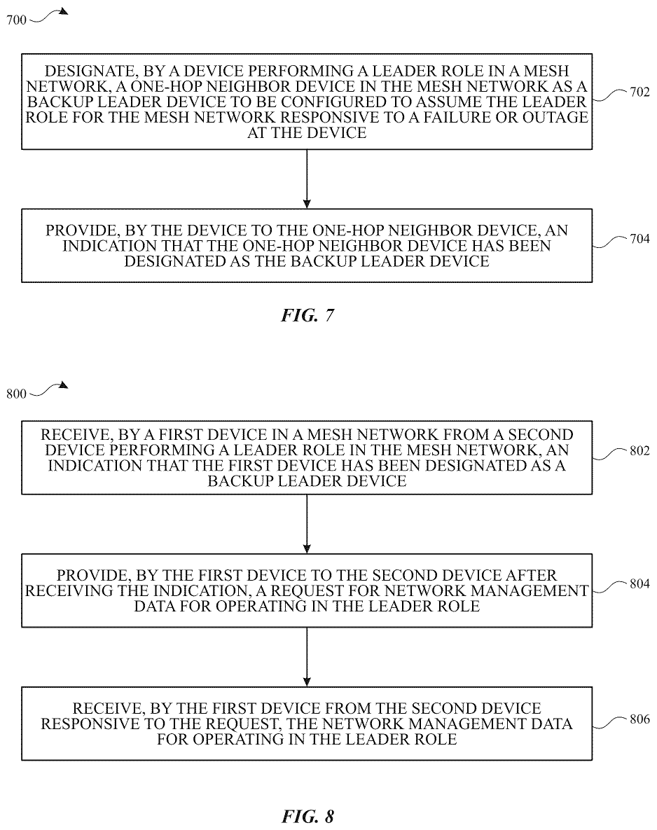

FIG. 7 is a flow chart of an example process 700 that may be performed in connection with a triggered role change for a networked device in accordance with one or more implementations. For explanatory purposes, the process 700 is primarily described herein with reference to the leader 154L of FIGS. 1 and 3. However, the process 700 is not limited to the leader 154L of FIGS. 1 and 3, and one or more blocks (or operations) of the process 700 may be performed by one or more other components of other suitable devices and/or servers. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, a device (e.g., a router 154, such as leader 154L) performing a leader role in a mesh network (e.g., mesh network 150), may designate a one-hop neighbor device (e.g., device 300) in the mesh network as a backup leader device to be configured to assume the leader role for the mesh network responsive to a failure or outage at the device. The device may be a router or a router-eligible end device (REED). For example, performing the leader role may include distributing network-wide configuration information for the mesh network to a plurality of devices (e.g., end devices 152 and routers 154), including the one-hop neighbor device, on the mesh network. For example, designating the one-hop neighbor device as the backup leader device may include designating the one-hop neighbor device as the backup leader device based on a prior communication (e.g., an advertisement, such as an MLE advertisement, as discussed in connection with FIG. 4) from the one-hop neighbor device and a set of criteria. For example, the set of criteria may include limits or thresholds for any or all of a 2-way link quality, a leader weight, a thread version, connectivity information, and/or Thread Radio Encapsulation Link (TREL) capabilities. In one or more implementations, a higher priority for a backup leader device candidate may be set for a device that better satisfies the set of criteria.

At block 704, the device may provide, to the one-hop neighbor device, an indication that the one-hop neighbor device has been designated as the backup leader device. For example, the indication may be provided in an advertisement, such as an MLE advertisement (e.g., including a leader candidate Type-Length-Value (TLV) message or a router TLV indicating the backup leader device candidates).

In one or more implementations, the device may also receive, from the backup leader device after providing the indication, a request for network management data for operating in the leader role. The device may also provide, to the backup leader device responsive to the request and while continuing to perform the leader role, the network management data for operating in the leader role. For example, the network management data may include a router identifier map (e.g., and/or other data as discussed in connection with the MLE Link Accept message of FIG. 4) for a plurality of routers (e.g., routers 154) in the mesh network. As examples, receiving the request may include receiving the request periodically from the backup leader device, and/or responsive to a change in the mesh network (e.g., one or more devices joining, leaving, or changing roles in the mesh network).

In one or more implementations, designating the one-hop neighbor device as the backup leader device may include designating the one-hop neighbor device as a first backup leader device candidate with a first priority, and designating another one-hop neighbor device (e.g., device 302) as a second backup leader device candidate with a second priority different from the first priority. In these implementations, providing the indication that the one-hop neighbor device has been designated as the backup leader device may include providing, by the device to a plurality of one-hop neighbor devices (e.g., the device 300, the device 302, and/or one or more other one-hop neighbor devices including one-hop neighbor devices not identified as backup leader device candidates), an indication that the one-hop neighbor device has been designated as the first backup leader device candidate with the first priority and that the other one-hop neighbor device has been designated as the second backup leader device candidate with the second priority.

In one or more implementations, the device (e.g., leader 154L) performing the leader role in the mesh network, may identify an upcoming event (e.g., a software update or other planned outage) at the device, and may provide, to the backup leader device(s) responsive to identifying the upcoming event, a notification to assume the leader role for the mesh network at a specified upcoming time (e.g., an outage time, such as a LeaderOutageTime, as discussed in connection with FIG. 5).

FIG. 8 is a flow chart of an example process 800 that may be performed in connection with a triggered role change for a networked device in accordance with one or more implementations. For explanatory purposes, the process 800 is primarily described herein with reference to a router 154 of FIGS. 1 and 3. However, the process 800 is not limited to the router 154 of FIGS. 1 and 3, and one or more blocks (or operations) of the process 800 may be performed by one or more other components of other suitable devices and/or servers. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, a first device (e.g., a router 154, such as device 300) in a mesh network (e.g., mesh network 150) may receive, from a second device (e.g., another router 154, such as leader 154L) performing a leader role in the mesh network, an indication that the first device has been designated as a backup leader device. For example, the indication may be received in an advertisement, such as an MLE advertisement (e.g., including a leader candidate Type-Length-Value (TLV) message or a router TLV indicating the backup leader device candidates). For example, in one or more implementations, the indication may include an indication that the first device has been designated as a first backup leader device candidate with a first priority, and that a third device (e.g., device 302) in the mesh network has been designated, by the second device, as a second backup leader candidate with a second priority different from the first priority.

The first device may then perform backup leader device operations. For example, the backup leader device operations may include preparing the first device to operate in the leader role by, at block 804, providing, by the first device to the second device after receiving the indication, a request for network management data for operating in the leader role, and, at block 806, receiving, by the first device from the second device responsive to the request, the network management data for operating in the leader role (e.g., as discussed herein in connection with FIG. 4).

In one or more implementations, the first device may also provide (e.g., in a MLE Link Request or a CoAp LeaderDatabaseReq message) a request for updated network management data to the second device periodically and/or responsive to a change in the mesh network (e.g., as discussed in connection with FIG. 4). In one or more implementations, the first device may set, based on the first priority, a jitter time for assuming the leader role (e.g., as discussed in connection with FIGS. 5 and 6). In one or more implementations, the first device may also receive, from the second device, a notification to assume the leader role for the mesh network at a specified upcoming time, and may assume, responsive to the notification (e.g., and after a jitter time), the leader role for the mesh network (e.g., as discussed in connection with FIG. 5). In one or more implementations, responsive to the notification and prior to assuming the leader role, the first device may provide, to the second device, an indication that the first device will assume the leader role (e.g., as discussed in connection with FIG. 5).

In one or more implementations, the first device may detect an outage at the second device, and may assume, responsive to detecting the outage (e.g., and after a jitter time), the leader role for the mesh network (e.g., as discussed in connection with FIG. 6). For example, detecting, the outage at the second device may include monitoring one or more communications (e.g., advertisements, such as MLE advertisements) associated with the second device to determine whether any of the one or more communications meet one or more conditions that indicate the outage. As examples, the one or more conditions that indicate the outage may include a request from the second device to join mesh network, or a missing expected communication from second device.

FIG. 9 illustrates an electronic system 900 with which one or more implementations of the subject technology may be implemented. The electronic system 900 can be, and/or can be a part of, any one of the electronic devices 110 or 112, the end devices 152, the router 154, and/or the server 120 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a flash drive, and its corresponding solid-state drive) may be used as the permanent storage device 902. Like the permanent storage device 902, the system memory 904 may be a read-and-write memory device. However, unlike the permanent storage device 902, the system memory 904 may be a volatile read-and-write memory, such as random-access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input device interface 914 and output device interface 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the electronic device 110 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
designating, by a device performing a leader role in a mesh network, a one-hop neighbor device in the mesh network as a backup leader device to be configured to assume the leader role for the mesh network responsive to a failure or outage at the device; and
providing, by the device to the one-hop neighbor device, an indication that the one-hop neighbor device has been designated as the backup leader device.

2. The method of claim 1, wherein the device comprises a router or a router-eligible end device.

3. The method of claim 1, wherein performing the leader role comprises distributing network-wide configuration information for the mesh network to a plurality of devices, including the one-hop neighbor device, on the mesh network.

4. The method of claim 1, further comprising:
receiving, by the device from the backup leader device after providing the indication, a request for network management data for operating in the leader role; and
providing, by the device to the backup leader device responsive to the request and while continuing to perform the leader role, the network management data for operating in the leader role.

5. The method of claim 4, wherein the network management data comprises a router identifier map for a plurality of routers in the mesh network.

6. The method of claim 4, wherein receiving the request comprises receiving the request periodically from the backup leader device.

7. The method of claim 4, wherein receiving the request comprises receiving the request from the backup leader device responsive to a change in the mesh network.

8. The method of claim 1, wherein designating the one-hop neighbor device as the backup leader device comprises:
designating the one-hop neighbor device as a first backup leader device candidate with a first priority; and
designating an other one-hop neighbor device as a second backup leader device candidate with a second priority different from the first priority.

9. The method of claim 8, wherein providing the indication that the one-hop neighbor device has been designated as the backup leader device comprises providing, by the device to a plurality of one-hop neighbor devices, an indication that the one-hop neighbor device has been designated as the first backup leader device candidate with the first priority and that the other one-hop neighbor device has been designated as the second backup leader device candidate with the second priority.

10. The method of claim 1, wherein designating the one-hop neighbor device as the backup leader device comprises designating the one-hop neighbor device as the backup leader device based on a prior communication from the one-hop neighbor device and a set of criteria.

11. The method of claim 1, further comprising:
identifying, by the device performing the leader role in the mesh network, an upcoming event at the device; and
providing, by the device to the backup leader device responsive to identifying the upcoming event, a notification to assume the leader role for the mesh network at a specified upcoming time.

12. A method, comprising:
receiving, by a first device in a mesh network from a second device performing a leader role in the mesh network, an indication that the first device has been designated as a backup leader device; and
performing backup leader device operations at the first device, the backup leader device operations comprising preparing the first device to operate in the leader role by:
providing, by the first device to the second device after receiving the indication, a request for network management data for operating in the leader role; and
receiving, by the first device from the second device responsive to the request, the network management data for operating in the leader role.

13. The method of claim 12, further comprising, periodically providing a request for updated network management data to the second device.

14. The method of claim 12, further comprising, providing a request for updated leader network management data to the second device responsive to a change in the mesh network.

15. The method of claim 12, wherein the indication that the first device has been designated as a backup leader device comprises an indication that the first device has been designated as a first backup leader device candidate with a first priority, and that a third device in the mesh network has been designated, by the second device, as a second backup leader candidate with a second priority different from the first priority.

16. The method of claim 15, further comprising setting, by the first device and based on the first priority, a jitter time for assuming the leader role.

17. The method of claim 12, further comprising:
receiving, by the first device from the second device, a notification to assume the leader role for the mesh network at a specified upcoming time; and
assuming, by the first device responsive to the notification, the leader role for the mesh network.

18. The method of claim 17, further comprising, responsive to the notification and prior to assuming the leader role:
providing, from the first device to the second device, an indication that the first device will assume the leader role.

19. The method of claim 12, further comprising:
detecting, by the first device, an outage at the second device; and
assuming, by the first device responsive to detecting the outage, the leader role for the mesh network.

20. The method of claim 19, wherein detecting, by the first device, the outage at the second device comprises:
monitoring one or more communications associated with the second device to determine whether any of the one or more communications meet one or more conditions that indicate the outage.

21. The method of claim 20, wherein the one or more conditions that indicate the outage comprise:
a request from the second device to join mesh network; and
a missing expected communication from second device.

22. A device, comprising:
one or more processors configured to:
designate, while the device is performing a leader role in a mesh network, one of a plurality of one-hop neighbor devices in the mesh network as a backup leader device to be configured to assume the leader role for the mesh network responsive to a failure or outage at the device; and
provide, for transmission to the plurality of one-hop neighbor devices, an indication that the one of the plurality of one-hop neighbor devices has been designated as the backup leader device.
